(19) United States
(12) Patent Application Publication
(10) Pub. No.: US 2017/0321418 A1
(43) Pub. Date: Nov. 9, 2017

(54) FIRE-RESISTANT CONSTRUCTION PANEL

(71) Applicants: Hervey TREMBLAY, Thetford Mines, Quèbec (CA); Rhèal THIBAULT, Thetford Mines, Quèbec (CA)

(72) Inventor: Hervey TREMBLAY, Thetford Mines, Quèbec (CA)

(21) Appl. No.: 15/531,919

(22) PCT Filed: Dec. 2, 2015
(86) PCT No.: PCT/CA2015/000590

§ 371 Date: May 31, 2017

Related U.S. Application Data
(60) Provisional application No. 62/086,378, filed on Dec. 2, 2014.

(51) Int. Cl. E04B 1/94; E04C 2/26; C09K 21/02; B32B 9/04; B32B 9/00; E04C 3/12; B32B 3/26

(52) U.S. Cl. CPC E04B 1/944; E04C 3/122; E04C 2/26; B32B 3/266; B32B 9/041; B32B 9/005; C09K 21/02

(57) ABSTRACT

A fire-resistant construction panel (10) includes a structural panel (12) as the web component of an I-joist (24) having an exposed surface (14) and a magnesium oxide board (18) covering the exposed surface (14). Alternately, the fire-resistant construction panel (10′) includes a load-resistant magnesium oxide board (30) being a structural element as the web of an I-joist (24′).

### CROSS REFERENCE TO RELATED APPLICATIONS

The present patent application claims benefit of prior U.S. Provisional Application for Patent Ser. No. 62/086,378 filed on Dec. 2, 2014, which is incorporated herein by reference.

### TECHNICAL FIELD

The present disclosure relates to a construction panel for main use in the building industry, and more specifically to a fire-resistant construction panel or board, and a method of using the same.

### BACKGROUND OF THE INVENTION

In the building industry, it is now common to use the engineered wood joist, commonly known as I-joist, as the main beam type for floorings and the like because of its great strength in relation to its size and weight. These I-joists essentially eliminate most problems that occur with conventional wood joists or solid lumbers, i.e. bowing, crowning, twisting, cupping, checking or splitting. Moreover, because of their low or no shrinkage, I-joists also help eliminating squeaky floors. I-joists are essentially made of a vertical web generally received in two grooves made into the opposite flanges, and assembled and secured thereto via water-resistant glue or the like. The flanges are typically made from laminated veneer lumber or solid wood (such as common ‘2×3’ (or 5 cm×8 cm) or ‘2×4’ (or 5 cm×10 cm)) finger-jointed together for ultimate strength, while the web is typically made from plywood, laminated veneer lumber or oriented strand board (OSB).

One of the main problems associated with these I-joists is that they are not specifically resistant to the fire which may propagate relatively rapidly therealong.

Accordingly, there is a need for an improved fire-resistant construction panel or board.

### SUMMARY OF THE INVENTION

In order to overcome the limitations and problems discussed above, the main objective of the present invention is to provide for an improved fire-resistant construction panel board and a method of using the same.

An advantage of the present invention is to provide a fire-resistant construction panel for use in the building industry and having a good resistance to heat and fire propagation, as well as being resistant to humidity, moisture and fungi.

Another advantage of the present invention is to provide a fire-resistant construction panel that can be used either as a protective layer of the web of an I-joist or, along with load-resistant properties, as the web of an I-joist.

A further advantage of the present invention is to provide a fire-resistant construction panel that can be used directly as a wall panel (including ceiling) or subfloor panel, or be assembled with other construction parts to form any other pre-assembled components for use in the building industry.

According to an aspect of the present invention, there is provided a fire-resistant construction panel comprising a load-resistant magnesium oxide board being a structural element.

In one embodiment, the load-resistant magnesium oxide board includes a structural lattice element embedded therein.

Conveniently, the structural lattice element comprises at least one of metallic netting, non-metallic netting, fiberglass sheet, carbon fiber sheet, composite material, and geo-polymeric material.

In one embodiment, the load-resistant magnesium oxide board is a magnesium oxide, magnesium chloride, perlite, sawdust and fiber glass laminate panel.

In one embodiment, the load-resistant magnesium oxide board is a web component of an I-joist.

According to another aspect of the present invention, there is provided a fire-resistant construction panel comprising: a structural panel having an exposed surface, and a magnesium oxide board covering the exposed surface.

In one embodiment, the structural panel has two first and second exposed surfaces generally facing away from one another, the fire-resistant construction panel including first and second magnesium oxide boards covering the first and second exposed surfaces, respectively.

In one embodiment, the structural panel is a web component of an I-joist.

In one embodiment, the magnesium oxide board is a magnesium oxide, magnesium chloride, perlite, sawdust and fiber glass laminate panel.

These and other advantages and objects will be apparent in view of the following detailed description in connection with the accompanying drawings.

### BRIEF DESCRIPTION OF THE DRAWINGS

Embodiments of the disclosure will be described by way of examples only with reference to the accompanying drawings, in which:

FIG. 1 is a broken sectioned perspective view of a fire-resistant construction panel in accordance with a first illustrative embodiment of the present disclosure; and

FIG. 2 is a broken sectioned perspective view of a fire-resistant panel in accordance with a second illustrative embodiment of the present disclosure.

Similar references used in different Figures denote similar components.

### DETAILED DESCRIPTION OF THE INVENTION

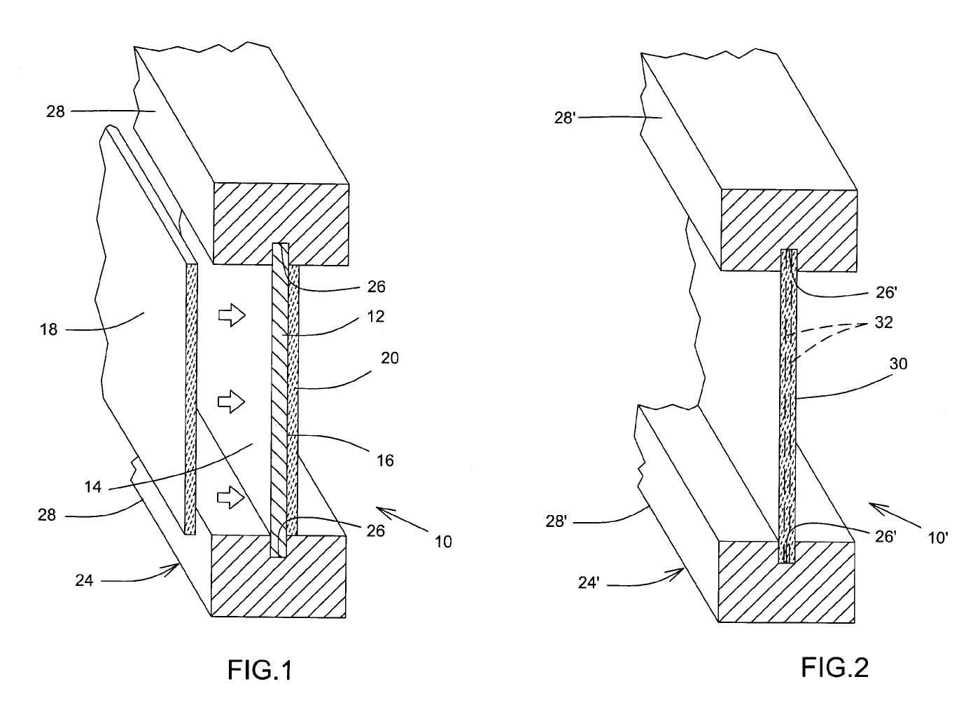

Referring to FIG. 1, a fire-resistant construction panel 10, in accordance with a first illustrative embodiment of the present disclosure, generally comprises a structural panel 12 having an exposed surface 14, typically first 14 and second 16 exposed surfaces generally facing away from one another, and a magnesium oxide board 18, typically first 18 and second 20 magnesium oxide boards covering the respective exposed surfaces 14, 16. Each magnesium oxide board 18, 20 is typically secured to the structural panel 12 via a water-resistant adhesive (not shown) such as a structural glue or mechanical fasteners (not shown) such as staples or the like depending on the actual size on the board 18, 20. The protective magnesium oxide boards 18, 20 may have a thickness varying between about one sixteenth of an inch ( 1/16 in or 1.6 mm) and about three sixteenths of an inch ( 3/16 in or 4.8 mm), and preferably about one eighth of an inch (⅛ in or 3.2 mm).

As shown in FIG. 1, the structural panel 12 is a typical web component of an I-joist 24 secured into respective grooves 26 of the top and bottom flanges 28 typically made out of wood, such that the fire-resistant construction panel 10 is integrated into a now fire-resistant I-joist 24 for use such as in floors.

Alternatively, as shown in FIG. 2, a fire-resistant construction panel 10′, in accordance with a second illustrative embodiment of the present disclosure, generally comprises a load-resistant magnesium oxide board 30 being a structural element.

Typically, the load-resistant magnesium oxide board 30 includes a structural lattice element 32 embedded therein. Conveniently, the structural lattice element 32 comprises at least one of metallic netting, non-metallic netting, fiberglass sheet, carbon fiber sheet, composite material, and geo-polymeric material.

In the embodiment shown in FIG. 2, the load-resistant magnesium oxide board 30 is a web component of an I-joist 24′ secured into respective grooves 26′ of the top and bottom flanges 28′.

Typically, the load-resistant magnesium oxide board 30 may have a thickness varying between about one quarter of an inch (¼ in or 6.3 mm) and about half an inch (½ in or 12.7 mm), and preferably about three eighths of an inch (⅜ in or 9.5 mm). The load-resistant magnesium oxide board 30, and also the magnesium oxide board 18, 20, is typically a magnesium oxide, magnesium chloride, perlite, sawdust and fiber glass laminate panel, or the like. Similarly, the load-resistant magnesium oxide board 30 can also be a laminated board.

Although not illustrated, the fire-resistant construction panel 10, 10′ of the present invention can be used at different locations in a building construction, such as in covering wall surfaces (including ceiling walls), or as subfloor panels, or can be assembled with other construction parts to form any other pre-assembled components for use in the building industry.

The present invention also refers to a method of using the fire-resistant construction panel 10, 10′ by having it as being at least part of a web of an I-joist, namely as a protective magnesium oxide board 18, 20 or as a load-resistant magnesium oxide board 30.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope of the present disclosure and as hereinafter claimed.

What is claimed is:

1. A fire-resistant construction panel (10′), comprising:
a load-resistant magnesium oxide board (30) being a structural element.

2. The construction panel (10′) of claim 1, wherein the load-resistant magnesium oxide board (30) includes a structural lattice element (32) embedded therein.

3. The construction panel (10′) of claim 2, wherein the structural lattice element (32) comprises at least one of metallic netting, non-metallic netting, fiberglass sheet, carbon fiber sheet, composite material, and geo-polymeric material.

4. The construction panel (10′) of claim 1, wherein the magnesium oxide board (30) is a magnesium oxide, magnesium chloride, perlite, sawdust and fiber glass laminate panel.

5. The construction panel (10′) of claim 1, wherein the magnesium oxide board (30) is a web component of an I-joist (24′).

6. The construction panel (10′) of claim 1, wherein the magnesium oxide board (30) is a laminated board.

7. A fire-resistant construction panel (10), comprising:
a structural panel (12) having an exposed surface (14), and
a magnesium oxide board (18) covering the exposed surface (14).

8. The construction panel (10) of claim 7, wherein the structural panel (12) has two first (14) and second (16) exposed surfaces generally facing away from one another, the fire-resistant construction panel (10) including first (18) and second (20) magnesium oxide boards covering the first (14) and second (16) exposed surfaces, respectively.

9. The construction panel (10) of claim 8, wherein the structural panel (12) is a web component of an I-joist (24).

10. The construction panel (10) of claim 7, wherein the magnesium oxide board (18) is a magnesium oxide, magnesium chloride, perlite, sawdust and fiber glass laminate panel.
